(19) United States
(12) Patent Application Publication
(10) Pub. No.: US 2025/0095395 A1
(43) Pub. Date: Mar. 20, 2025

(54) METHOD FOR ASSOCIATING NATURAL LANGUAGE WITH DIGITAL IMAGES

(71) Applicant: Alchemie Solutions, Inc., Bloomfield, MI (US)

(72) Inventors: Julia English WINTER, Bloomfield, MI (US); Joseph ENGALAN, Royal Oak, MI (US); Sarah WEGWERTH, Maplewood, MN (US); Alexa URREA, San Antonio, TX (US); Katherine ROCHON, Troy, MI (US); Jacob ZYSNARSKI, Rochester Hills, MI (US)

(73) Assignee: Alchemie Solutions, Inc., Bloomfield, MI (US)

(21) Appl. No.: 18/889,936

(22) Filed: Sep. 19, 2024

Related U.S. Application Data
(60) Provisional application No. 63/539,175, filed on Sep. 19, 2023.

(51) Int. Cl. G06V 30/262; G06V 10/82

(52) U.S. Cl. CPC G06V 30/274; G06V 10/82

(57) ABSTRACT

A method for associating natural language with digital images is provided. The method includes steps of receiving a digitized image; identifying elements in the digitized image as identified elements; associating a contextual label to each element that becomes content for each element; identifying predetermined relationships between the identified elements; describing the content for each element individually and relationships between the elements with a predetermined language; engineering a prompt to be sent to a Language Model (LM); and receiving a response from the LM. Characteristically, the prompt is configured to provide an LM input and instruct the LL regarding a manner and configuration for responding to the LM input.

### CROSS-REFERENCE TO RELATED APPLICATIONS

This application claims the benefit of U.S. provisional application Ser. No. 63/539,175 filed Sep. 19, 2023, the disclosure of which is hereby incorporated in its entirety by reference herein.

### TECHNICAL FIELD

In at least one aspect, the present invention relates to a system and method for analysis and providing natural language description of digital images.

### SUMMARY

In at least one aspect, a method for associating natural language with digital images is provided. The method includes steps of receiving a digitized image; identifying elements in the digitized image as identified elements; associating a contextual label to each element that becomes content for each element; identifying predetermined relationships between the identified elements; describing the content for each element individually and relationships between the elements with a predetermined language; engineering a prompt to be sent to a language model (e.g., a Large Language Model (LLM) or a Small Language Model (SLM)); and receiving a response from the language model. Characteristically, the prompt is configured to provide a language model input and instruct the language model regarding a manner and configuration for responding to the language model input.

In another aspect, the method further includes training a neural network to identify elements in a digitized image. The training process involves collecting a dataset of annotated digitized images, where each image contains pre-labeled elements, such as chemical structures, electrical components, or blueprint symbols. The dataset is enhanced using data augmentation techniques, such as rotation, scaling, cropping, and noise addition, to improve the neural network's generalization capabilities. A convolutional neural network (CNN) architecture with multiple convolutional layers is designed and implemented to detect spatial relationships between the elements. The neural network is then trained using annotated images, with network weights being adjusted based on the identified elements and their relationships through forward and backward propagation. Finally, the network's accuracy and performance are evaluated using validation sets as well as optional metrics such as precision, recall, F1-score, and a confusion matrix, to ensure reliable recognition of elements in the digitized images.

In another aspect, the present invention provides a system that leverages a family of artificial intelligence-based large language models that include but are not limited to generative pre-trained transformers (GPT) models as well as a new “bio-data” language.

In another aspect, a system is designed to make interactive STEM diagrams accessible to BLV individuals. The system includes four key components: Real-time Alt Text Generation Engine, Keyboard-Accessible Control Interface (Nicole's Controls), AI-Driven Learning Assistant (Piph), and Image Export with Embedded Alt Text. The Real-time Alt Text Generation Engine generates dynamic alt text descriptions for interactive STEM diagrams. These descriptions provide both high-level context and detailed information about diagram elements, such as chemical bonds, electron pairs, physical forces, or mathematical equations. The Keyboard-Accessible Control Interface (Nicole's Controls) is a form-driven interface that allows users to interact with diagrams using keyboard inputs instead of a mouse. The interface provides feedback through dynamically generated alt text, describing each action taken by the user. The AI-Driven Learning Assistant (Piph) uses a language model (e.g., a large language model (LLM) or a small language model (SLM)) to respond to user queries based on the alt text descriptions. It provides personalized assistance, helping users explore diagram content and guiding them through learning objectives. The Image Export with Embedded Alt Text allows the export of diagrams with embedded alt text in the metadata, making the diagrams accessible to screen readers when shared or reused.

In another aspect, a method for delivering interactive STEM education tools that are accessible to blind and low-vision individuals is provided. The method includes generating real-time alt text descriptions for diagrams based on configuration data from a STEM interactive tool, where the alt text descriptions provide a contextual overview, component details, and the relationships between components. The method further enables user interaction with an STEM educations tool through a form-driven, keyboard-accessible control interface, allowing users to select and manipulate components in the diagram without requiring a mouse. Additionally, an artificial intelligence-driven learning assistant is configured to answer user queries based on the alt text descriptions, offering personalized guidance to help users understand and manipulate the diagram. The method also embeds these alt text descriptions into the metadata of an exportable image generated by the STEM interactive tool, ensuring that the image remains accessible for future use.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1. Schematic of the Epiphany system.

FIG. 2. Schematic of a system for providing interactive STEM education tools accessible to blind and low-vision individuals.

FIG. 3. Schematic of the Epiphany system for the alt-text use case.

FIG. 4. Schematic of the Epiphany system for the assistance use case.

FIG. 5. Schematic of the Epiphany system for the tutoring use case.

FIG. 6. Schematic of the Epiphany system for the automated diagram training use.

FIG. 7. Table 1: Structures used and results from testing the auto-generated alt text.

FIG. 8. A tactile diagram and description of formaldehyde.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

When referring to a numerical quantity, in a refinement, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

For any device described herein, linear dimensions and angles can be constructed with plus or minus 50 percent of the values indicated rounded to or truncated to two significant figures of the value provided in the examples. In a refinement, linear dimensions and angles can be constructed with plus or minus 30 percent of the values indicated rounded to or truncated to two significant figures of the value provided in the examples. In another refinement, linear dimensions and angles can be constructed with plus or minus 10 percent of the values indicated rounded to or truncated to two significant figures of the value provided in the examples.

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “electrical communication” means that an electrical signal is either directly or indirectly sent from an originating electronic device to a receiving electrical device. Indirect electrical communication can involve processing of the electrical signal, including but not limited to, filtering of the signal, amplification of the signal, rectification of the signal, modulation of the signal, attenuation of the signal, adding of the signal with another signal, subtracting the signal from another signal, subtracting another signal from the signal, and the like. Electrical communication can be accomplished with wired components, wirelessly connected components, or a combination thereof.

The term “one or more” means “at least one” and the term “at least one” means “one or more.” The terms “one or more” and “at least one” include “plurality” as a subset.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

The term “electrical signal” refers to the electrical output from an electronic device or the electrical input to an electronic device. The electrical signal is characterized by voltage and/or current. The electrical signal can be stationary with respect to time (e.g., a DC signal) or it can vary with respect to time.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

“Alt text” means a brief textual description that is used to provide descriptions of an image, graphic, or other non-textual elements on a digital document.

“STEM education tools” are essential resources and technologies designed to enhance teaching and learning in Science, Technology, Engineering, and Mathematics. These tools engage students through interactive, hands-on activities that promote problem-solving and a deeper understanding of complex concepts. Digital simulations provide virtual environments for exploring scientific experiments and engineering processes, while robotics kits enable students to build and program robots, fostering engineering and coding skills. In classrooms, 3D printers introduce students to design and prototyping, and coding platforms teach programming languages. Mathematics software helps visualize complex problems, and virtual or augmented reality can simulate real-world applications in science and engineering. Chemical structure software, like ChemDraw or Lewis Structure explorers, is another key tool that enables students to create and manipulate chemical diagrams, helping them understand molecular structures and reactions. Scientific instruments, such as microscopes and data sensors, allow students to conduct experiments and analyze data, while interactive learning platforms provide exercises and tutorials to make STEM subjects more accessible and engaging.

“STEM diagrams” are visual representations used in Science, Technology, Engineering, and Mathematics to illustrate and simplify complex concepts, processes, or data. These diagrams play a critical role in helping students and professionals visualize and understand abstract ideas. Examples include chemical structures, which depict molecules and atomic bonds, mathematical graphs that plot equations or data relationships, and circuit diagrams used to represent electrical systems. Engineering blueprints provide detailed designs of mechanical systems or structures, while flowcharts are used to show the steps in processes or algorithms in technology and computer science. In physics, diagrams such as free-body or circuit layouts are essential for representing forces and motions. These visuals are fundamental in education and practice, making it easier to explain relationships and solve problems across various STEM fields.

A “language model” is a computational model designed to understand, generate, and predict human language. It works by analyzing a vast amount of text data and learning patterns, structures, and rules of language, which allows it to predict the next word in a sequence, generate coherent sentences, or perform various natural language processing (NLP) tasks such as translation, summarization, or answering questions.

A “large language model” is a type of language model that has been trained on an extremely large dataset and typically contains billions to hundreds of billions of parameters. The large size enables these models to perform more complex tasks, generate more coherent text, and handle diverse linguistic challenges with a higher degree of fluency and accuracy. Examples include GPT (Generative Pretrained Transformer) models like GPT-3 and GPT-4. The “large” refers not only to the model's dataset but also to the number of parameters, computational power, and memory required for training and operation.

A “small language model” is a language model with significantly fewer parameters compared to large language models, typically in the range of millions to low billions of parameters. These models are faster and less computationally expensive to train and deploy, making them suitable for more specialized tasks or applications with limited resources. However, they may not exhibit the same level of generalization, fluency, or ability to handle diverse and complex language tasks as large language models.

### Abbreviations:

“Alt text” means alternative text.
“D2L” means Desire2Learn.
“LLM” means a large language model.
“LM” means language model. Each instance of LM can be replaced by LLM or SLM.
“LMS” means learning management system.
“SLM” means a small language model.
“UDL” means Universal Design for Learning.

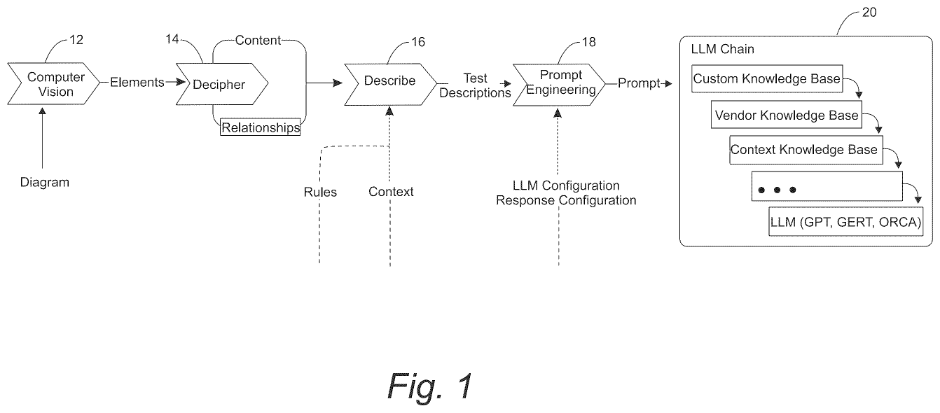

Referring to FIG. 1, a method and system for associating natural language with digital images is schematically illustrated. Epiphany system 10 includes a vision model 12, decipher module 14, describe module 16, prompt engineering module 18, and LM change model 20 (e.g., LLM chain module 20). Advantageously, the Epiphany system outputs natural language descriptions (e.g., Alt Text) of an input image. Vision model 12 receives a digitized image as input. The digitized image can be a bitmap image, a raster image, or a vector image. In a refinement, the digitized image can be a 3D image. Elements in the digitized image are identified by a trained machine learning algorithm, and in particular, by a trained neural network. For example, vision module 12 ingests a raster version of the diagram and runs it through a convolutional neural network to determine the elements it recognizes in the diagram. The convolutional neural network is trained to recognize elements with annotated diagrams (e.g., a thousand or more annotated images). The annotations in the annotated diagrams are identified by experts or at least people knowledgeable of the subject matter depicted in the images.

In another aspect, in order to train the convolutional neural network (CNN) for image recognition as described, a structured and comprehensive approach must be followed. The first step is to define the problem clearly. The objective of the neural network is to accurately identify and label elements in digitized images, including bitmap, raster, vector, and even 3D images, associating these elements with contextual labels based on pre-annotated data. This will allow the system to recognize elements like symbols, objects, or structures in diagrams. The dataset preparation begins by collecting a large and diverse set of annotated images relevant to the domain in question. These images can come from fields like chemistry, electrical engineering, or architecture, and be annotated by experts. The annotations should clearly identify all the relevant elements such as atoms, bonds, or components like resistors and capacitors in electrical diagrams. The dataset should be sufficiently large, with at least 1,000 annotated examples per element class. After collecting the raw data, data augmentation can be employed to increase dataset diversity and prevent overfitting. This is done by applying one or more transformations such as rotation (e.g., ±15° to ±45°), scaling (0.8× to 1.2×), cropping, flipping, noise addition, and contrast adjustment. These transformations will help the neural network generalize better, ensuring that the model can identify elements from different angles or scales. Once the dataset is prepared, the next step is designing the neural network architecture. For image processing tasks, a CNN is particularly effective due to its ability to capture spatial hierarchies. The input layer will accept images in various formats (e.g., RGB for raster images or grayscale for vector images), and a typical input size is 224×224 or 256×256 pixels. The CNN can have several convolutional layers, for example starting with 64 filters of 3×3 size, followed by Rectified Linear Unit (ReLU) activation. Additional convolutional layers can increase the number of filters (e.g., 128, 256, 512) to capture more complex features in the images. Pooling layers, such as max pooling with a 2×2 filter, are inserted after every two to three convolutional layers to reduce the spatial dimensions, preserving computational resources. After the final convolutional layer, the output is flattened and passed through fully connected layers with for example 512 to 1,024 neurons, followed by a final output layer with softmax activation for multi-class classification, predicting the labels for the identified elements. The training process for this CNN starts by defining a loss function, with categorical cross-entropy being a suitable choice for multi-class classification. The optimizer (e.g., for gradient descent) can be Adam, with an initial learning rate of 0.001 due to its adaptive learning rate properties, which are ideal for image recognition tasks. Key hyperparameters, such as batch size and learning rate, should be tuned carefully. For batch size, experiments with values like 32, 64, and 128 can be conducted to find the best balance between memory use and computational time. The learning rate can start at 0.001 but gradually decrease if the validation loss plateaus, using a learning rate scheduler. A typical training run may involve 50 to 100 epochs, but early stopping can be implemented to avoid overfitting. Early stopping can be triggered if the validation loss does not improve for 10 consecutive epochs. Evaluation metrics include not only accuracy but also precision, recall, and the F1-score, which are essential when identifying elements in imbalanced classes. A confusion matrix can be used to track true positives, false positives, and false negatives to better understand where the model may be misclassifying elements. To prevent overfitting and ensure model robustness, a portion (e.g., 20%) of the dataset should be set aside as a validation set. Additionally, k-fold cross-validation (e.g., 5-fold) can be used to further validate the model.

The preprocessing pipeline for training will involve normalizing pixel values to the range [0, 1] to speed up convergence. All images can be resized to a uniform size (e.g., 256×256) for consistency. During the training loop, batches of images and annotations are loaded, passed through the CNN for forward propagation, and the loss is calculated using categorical cross-entropy. The error is then backpropagated, updating the network weights using the Adam optimizer. As the model trains, checkpoints can be saved after each epoch where the validation accuracy improves, ensuring that the best version of the model is retained.

Once training is complete, the model can be evaluated on an unseen test set, and the performance metrics, such as accuracy, precision, recall, F1-score, and confusion matrix, can be reported. Additionally, feature importance can be visualized using techniques like Grad-CAM (Gradient-weighted Class Activation Mapping), which shows the parts of the image the network focuses on when making its predictions. If performance on specific element classes is unsatisfactory, further fine-tuning may be required, potentially adding more annotated examples for those classes or adjusting the network architecture.

After successful training, the model is ready for deployment in the Vision Model 12 for real-time image analysis. The trained model can be integrated into an inference pipeline that handles various input formats, providing detailed descriptions or guidance for different use cases such as chemistry diagrams or electrical schematics. To maintain and improve the model's performance over time, continuous learning can be employed, where new annotated images are collected, and the model is periodically retrained.

By following this detailed protocol, the CNN will be effectively trained to recognize and label elements in digitized images, enhancing the capabilities of the vision model for your application. If additional assistance is needed for implementation, let me know!

In another aspect, to train a convolutional neural network (CNN) specifically for recognizing chemical structures, the protocol begins by clearly defining the objective: to accurately identify chemical elements such as atoms, bonds, and electron movements within digitized chemical diagrams. The CNN should be capable of interpreting various input formats, including bitmap, raster, vector, or 3D images, and associating these elements with appropriate contextual labels. The ultimate goal is for the model to generate descriptions of these structures that can be further processed by large language models (LLMs) or small language models or other downstream systems, allowing for natural language descriptions of chemical structures. The first step in the process involves the preparation of a dataset. This dataset must consist of a wide range of digitized chemical diagrams, including examples from organic chemistry, inorganic chemistry, and complex reaction mechanisms. Each diagram can be annotated by experts in the field, with labels for key chemical elements such as individual atoms, bonds (single, double, triple, etc.), and even specific electron movements or lone pairs. The dataset must be diverse and large, ideally consisting of thousands of annotated diagrams to ensure that the neural network can generalize across different types of chemical structures. For effective training, at least 1,000 annotated images per class or chemical element type should be collected. Once the data is collected, it must be further augmented to improve the CNN's ability to generalize and prevent overfitting. Data augmentation techniques like rotation (e.g., +15° to)+45°, scaling, cropping, and adding noise will help the network better recognize chemical structures in various orientations and conditions. These augmented images should preserve the integrity of the chemical annotations, ensuring that bonds and atoms remain clearly identifiable after transformation. The next step is to design the CNN architecture. The input layer must accept images of chemical diagrams in various formats, such as raster or vector images, with a typical input size of 224×224 or 256×256 pixels. The CNN will have multiple convolutional layers, starting with 64 filters of 3×3 size, followed by ReLU (Rectified Linear Unit) activation to capture important features in the images. Additional convolutional layers will increase the number of filters (e.g., 128, 256, 512) to identify increasingly complex chemical structures. Max pooling layers with a 2×2 filter will be introduced after every 2-3 convolutional layers to reduce the spatial dimensions and ensure computational efficiency. After the final convolutional layer, the output will be flattened and passed through one or two fully connected layers, each with 512 to 1,024 neurons. The output layer will use softmax activation to predict the labels for different chemical elements and bonds. The training process involves defining the loss function, with categorical cross-entropy being the most appropriate choice for multi-class classification. The Adam optimizer is recommended due to its adaptive learning rate, which helps achieve faster convergence. The initial learning rate can be set at 0.001, with the option to reduce it if validation loss stagnates. The batch size will vary between 32, 64, and 128 depending on memory constraints and training speed. Training can proceed over 50-100 epochs, but early stopping can be implemented if the validation loss does not improve for 10 consecutive epochs, to avoid overfitting. To evaluate the model's performance, metrics such as accuracy, precision, recall, and F1-score will be used. A confusion matrix will help analyze which elements or bonds are being misclassified, giving insight into potential areas for improvement. A robust validation set, comprising 20% of the dataset, will be set aside to monitor the network's performance during training. Additionally, k-fold cross-validation will ensure the model's robustness and prevent overfitting. During training, the CNN will receive preprocessed images, with pixel values normalized to a [0, 1] range for faster convergence. All images will be resized to maintain uniform input dimensions. The training loop will involve forward propagation through the CNN, calculating loss, and backpropagating the error to update the weights. Model checkpoints will be saved after every epoch where the validation accuracy improves, ensuring that the best version of the model is retained. Once training is complete, the final model will be tested on an unseen test set, and performance metrics such as precision, recall, F1-score, and the confusion matrix will be reported. Techniques like Grad-CAM (Gradient-weighted Class Activation Mapping) can be used to visualize which parts of the chemical diagrams the CNN focuses on, helping to verify that the network is correctly identifying relevant chemical structures. Finally, after training and evaluation, the model can be deployed for real-time image analysis of chemical diagrams in the Vision Model 12. This allows the system to process new chemical diagrams and accurately describe their components, such as atoms and bonds. Continuous learning will be implemented by collecting new annotated diagrams over time and fine-tuning the model as necessary to maintain or improve accuracy. By following this protocol, the CNN will be effectively trained to recognize chemical structures in digitized diagrams, enabling advanced applications like natural language generation for chemical analysis. This model will enhance the Vision Model's capabilities in the field of chemistry, providing detailed and accurate descriptions of complex chemical structures.

Referring to FIG. 1, decipher module 14 receives the elements that were recognized by the computer vision module 12. Decipher module 14 identifies each element and adds a contextual label that becomes the content. Then, based on the content, it looks for known relationships between elements, generally based on proximity between elements in the image. For example, a bond between atoms can be identified.

In another aspect, a neural network can be trained to automatically detect and classify relationships between elements, such as Chemical bonds (single, double, triple, aromatic), Electron movement (arrows in reaction mechanisms), and Spatial relationships (proximity of atoms in a molecule, such as bond angles or molecular geometry). A neural network could be trained to understand how these elements interact based on expert-annotated datasets. This could be useful for analyzing more complex relationships in chemical diagrams, such as reaction mechanisms, intermolecular interactions, or even three-dimensional molecular configurations. Another important aspect of the invention is associating contextual labels with each identified element. A neural network could be used to interpret the broader context of the image and apply more precise and relevant labels. For example, in a chemical reaction diagram, the network could not only label individual atoms and bonds but also understand the functional groups or reaction centers, as well as predict the type of chemical reaction (e.g., substitution, addition, elimination). This would require combining vision models with contextual language models, enhancing the system's ability to generate accurate and contextually relevant descriptions

Describe module 16 operates on the output from decipher module 14. Subject matter experts (SME) provide the predetermined language to describe the content individually and the relationships between the content in the vernacular of the context. In a refinement, the predetermined language is specific to a category of the digitized image. The predetermined language can be used to form text descriptions. In a refinement, subject matter experts train a rules-based or AI system that provides contextual labels and expected relationships in a subject area. For example, a rubric (set of rules) given to us by the SME is used to filter our content and relationships through to create a better description of the diagram.

In another aspect, a neural network, such as a sequence-to-sequence (Seq2Seq) model or transformer-based models like GPT, could be used to generate more sophisticated natural language descriptions. The model could automatically translate the identified elements and their relationships into meaningful sentences, making the content accessible to users who need a natural language explanation of the diagram. It could also be fine-tuned for specific domains, such as organic chemistry, to use the correct jargon and technical terms.

Prompt engineering module 18 operates on the output from describe module 16. Prompt engineering module 18 engineers a prompt to be sent to a Large Language Model (LLM) or a Small Language Model. The prompt is configured to provide an LM input and instruct the LM regarding a manner and configuration for responding to the LM input. The purpose of the prompt engineering is to configure the LM input (determining the tone, temperature, etc. of the LM) and configure the response (tell the LM how it should respond). The LLM preamble, the LM response template, and all of the textual descriptions are sent to the Large Language Model Chain as the prompt.

LM chain module 20 receives the output from prompt engineering module 18. In this module, the prompt is further refined by many links in the LM chain. For example, a custom knowledge base can specify phrases and keywords that can be found and manipulated in the context of a predetermined goal of the AI system. A vendor-specific knowledge base can pinpoint the specific language used by our vendors. In a refinement, the prompt is further refined by a plurality of links in the LLM chain.

The refined prompt is then sent to a Large or Small Language Model such as GPT, BERT, LAMBDA, or any other general-purpose LM that are open source or provided by other companies. This prompt returns a response, which depending on the use case can be a detailed answer, guidance, or alt text. In a refinement, the response includes a detailed answer, guidance for a specific task, a detailed description of the digitized image, a detailed description of part of the digitized image, and/or alt text. In a further refinement, the response includes an LM preamble, an LM response template, and textual descriptions are sent to a Large Language Model Chain as the prompt.

In another aspect, the digitized image is an image of a chemical compound or chemical reaction. In such images, the elements include representations of atoms and chemical bonds. In a refinement, the elements further include representations of electron movement.

In another aspect, the digitized image is an image for electrical diagram analysis.

In another aspect, the digitized image is an image for blueprint analysis.

In another aspect, the digitized image is an image for a plumbing system.

In another aspect, the digitized image is an image for a plumbing system a mechanical system. In a refinement, the digitized image is an image for building standards.

In another aspect, one or more steps of the method set forth above are executed by a computer, a server, or a network of computers.

Beyond using a neural network to recognize elements in digitized chemical diagrams, several other aspects of the invention can also leverage neural networks to enhance their functionality. As set forth above, the system above describes identifying predetermined relationships between the elements in digitized images. A neural network could be trained to automatically detect and classify relationships between elements, such as Chemical bonds (single, double, triple, aromatic), Electron movement (arrows in reaction mechanisms), Spatial relationships (proximity of atoms in a molecule, such as bond angles or molecular geometry). In this regard, a neural network could be trained to understand how these elements interact based on expert-annotated datasets. This could be useful for analyzing more complex relationships in chemical diagrams, such as reaction mechanisms, intermolecular interactions, or even three-dimensional molecular configurations.

In another aspect, the Describe Module generates text descriptions for the elements and their relationships in the image. A neural network, such as a sequence-to-sequence (Seq2Seq) model or transformer-based models like GPT, could be used to generate more sophisticated natural language descriptions. The model could automatically translate the identified elements and their relationships into meaningful sentences, making the content accessible to users who need a natural language explanation of the diagram. It could also be fine-tuned for specific domains, such as organic chemistry, to use the correct jargon and technical terms.

In another aspect, contextual labels is associated with each identified element. A neural network could be used to interpret the broader context of the image and apply more precise and relevant labels. For example, in a chemical reaction diagram, the network could not only label individual atoms and bonds but also understand the functional groups or reaction centers, as well as predict the type of chemical reaction (e.g., substitution, addition, elimination). This would require combining vision models with contextual language models, enhancing the system's ability to generate accurate and contextually relevant descriptions.

In another aspect, a neural network could be employed to automatically detect errors or inconsistencies in the digitized image, such as misidentified elements or relationships. For instance, if the system identifies a chemical structure where the bonding or electron movement doesn't make chemical sense (e.g., a carbon atom with five bonds), the neural network could flag this as an error and suggest corrections. This feature could be particularly useful in educational or professional settings where diagrams are manually drawn and need verification.

In another aspect, the system describes use cases for assistance, where users can interact with diagrams in real-time and ask questions about their content. A neural network could support this by using natural language processing (NLP) to understand the user's queries and provide contextually accurate responses based on the diagram. For example, when a user asks about specific elements in a chemical structure, a neural network could interpret the question and highlight the relevant parts of the diagram, then provide an answer based on pre-trained knowledge about chemistry or specific diagrams.

In another aspect, in refinements where the system handles 3D images, a neural network could be applied to interpret three-dimensional molecular structures. This could involve training the network to recognize stereochemistry (e.g., R/S configurations), molecular conformations, or spatial arrangements in three-dimensional space. Neural networks designed for 3D data (such as 3D convolutional networks) could be utilized to identify and label these complex structures, providing a deeper level of analysis than is possible with 2D diagrams alone.

In another aspect, the Automated Diagram Training Use Case outlines the potential for automatically training the neural network using annotated diagrams. In this context, the system could use neural networks to automatically annotate new chemical diagrams or other domain-specific images by learning from a set of pre-annotated examples. Over time, this could reduce the need for manual annotations and expand the system's capabilities in handling different types of diagrams, such as electrical circuits, blueprints, or mechanical designs, beyond chemical structures.

In another aspect, if the system is applied to domains outside chemistry, such as electrical diagram analysis, blueprints, or mechanical systems, neural networks can be trained to recognize the components specific to those fields. For example, a CNN could be adapted to identify symbols and components in an electrical circuit or mechanical parts in a blueprint, with neural networks further interpreting how these components interact in their respective contexts. The same methods used for chemical diagrams (element identification, relationship mapping, contextual labeling) could be applied to these domains with minimal modification.

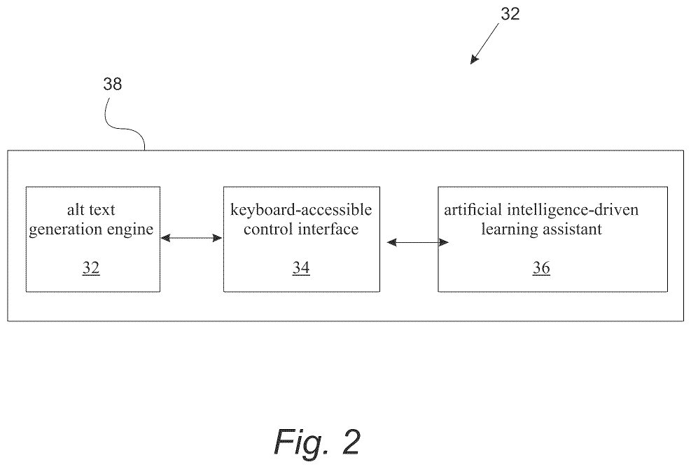

In another aspect, a system is designed to make interactive STEM diagrams accessible to blind and low-vision (BLV) individuals by addressing the challenges of providing detailed, real-time alt text and enabling user interaction through keyboard-based controls. Referring to FIG. 2, at the core of this system 30 is the real-time alt text generation engine 32, which automatically produces descriptive text for each component of an interactive STEM diagram. In a refinement, real-time alt text generation engine 32 is executed by a computing device. The alt text is dynamically generated based on the current configuration of the diagram and is structured to provide a comprehensive yet accessible explanation of the visual content. This text follows a predefined format that includes an initial high-level context, an overview of the key components, and further details about the relationships and specific characteristics of the diagram elements. For instance, in the context of a chemistry interactive such as a Lewis structure, the alt text would describe the atoms, bonds, charges, and electron pairs in a clear and organized manner, updating in real-time as the user interacts with the diagram. In a refinement, the alt text generation engine 32 applies a drill-down organization method to create the descriptions, wherein the overview provides a high-level summary, and additional layers of detail are available upon user request.

The system 30 also includes a keyboard-accessible control interface 34, which allows BLV users to interact with the diagrams without the need for a mouse. This form-driven interface provides users with intuitive navigation options, allowing them to add or modify elements within the diagram using drop-down menus and buttons. Each user action, such as adding an atom or bond, is followed by immediate feedback in the form of updated alt text that describes the action taken, ensuring that users are always aware of the current state of the diagram. The interface is designed to minimize cognitive load by avoiding complex keyboard commands, making it easier for BLV users to engage with the content. Therefore, system 30 typically includes a computing device 38 with a keyboard-accessible control interface 34.

In addition to the alt text generation and control interface, the system integrates an artificial intelligence-driven learning assistant 36 (named Piph), which uses large or small language models to provide personalized guidance. Artificial intelligence-driven learning assistant 36 enables users to ask specific questions about the diagram, such as inquiring about the formal charge of an atom or the bonds between elements, and it responds with detailed, context-aware information drawn from the alt text. The assistant can also guide users through learning objectives by offering hints and suggestions, making it a valuable tool for users who are not only interacting with the diagram but also learning the underlying STEM concepts. Artificial intelligence-driven learning assistant 36 enhances the accessibility and learning experience by offering a conversational way for BLV users to explore the content in greater depth.

To further support collaboration and content sharing, the system includes an image export feature (e.g., computer-implemented) that embeds the generated alt text into the metadata of the exported image file. This ensures that when the image is shared with others, particularly other BLV users or educators, the alt text remains accessible through screen readers, maintaining the diagram's usability. This feature allows BLV users to submit assignments or share their work with instructors and peers, facilitating a more inclusive learning environment.

This variation provides a comprehensive solution for making interactive STEM diagrams accessible to BLV individuals. By combining real-time alt text generation, a keyboard-based control interface, AI-driven learning support, and an image export function with embedded alt text, the system ensures that BLV users can independently interact with, learn from, and share STEM content. This innovation addresses the longstanding barriers that BLV individuals face in STEM education, enabling them to fully engage with complex visual materials and participate in interactive learning environments.

In another aspect, a method for delivering interactive STEM education tools that are accessible to blind and low-vision individuals using system 30 of FIG. 2 is provided. The method includes generating real-time alt text descriptions for diagrams based on configuration data from a STEM interactive tool, where the alt text descriptions provide a contextual overview, component details, and the relationships between components. The method further enables user interaction with an STEM educations tool through a form-driven, keyboard-accessible control interface, allowing users to select and manipulate components in the diagram without requiring a mouse. Additionally, an artificial intelligence-driven learning assistant is configured to answer user queries based on the alt text descriptions, offering personalized guidance to help users understand and manipulate the diagram. The method also embeds these alt text descriptions into the metadata of an exportable image generated by the STEM interactive tool, ensuring that the image remains accessible for future use.

In another aspect, a computer-readable medium is disclosed containing instructions that, when executed by a processor, implement a method for delivering accessible STEM educational content for blind and low-vision individuals. This method includes instructions for generating structured alt text descriptions based on the configuration data of a STEM diagram. It also includes instructions for enabling interaction with the diagram through a form-based, keyboard-accessible interface. Furthermore, it incorporates instructions for integrating an artificial intelligence-driven assistant that provides personalized feedback based on user queries and the diagram descriptions. Lastly, the method includes instructions for exporting an image file with embedded alt text in the image metadata, ensuring future accessibility for screen reader users.

The following examples illustrate the various embodiments of the present invention. Those skilled in the art will recognize many variations that are within the spirit of the present invention and scope of the claims.

### 1. Alt Text Use Case

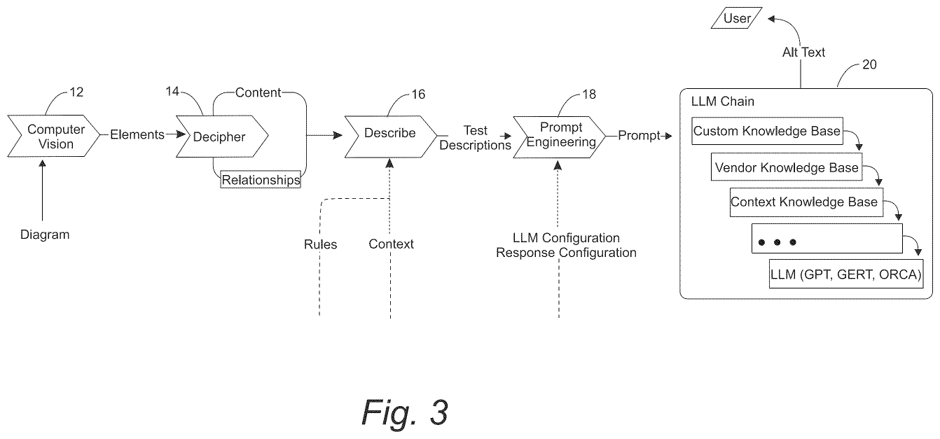

Referring to FIG. 3, an alt text use Case applying Epiphany is schematically illustrated. The Epiphany System uses computer vision, context given to us by subject matter experts (SME's), and a large language model chain to create rich alternative text descriptions to make diagrams more accessible.

Alt Text Example 1: Publishers can link their diagrams with the Epiphany system to get rich alt-text descriptions to use in their textbooks. Then, publishers can make their content accessible to all students and go beyond their accessibility requirements.

Alt Text Example 2: D2L, an LMS, is missing out on potential customers because its system is not fully accessible to blind students. Epiphany can be integrated with D2L (an LMS) so that when professors upload images of diagrams to their course content, rich alt text is automatically written and added to their content.

2. Assistance Use case

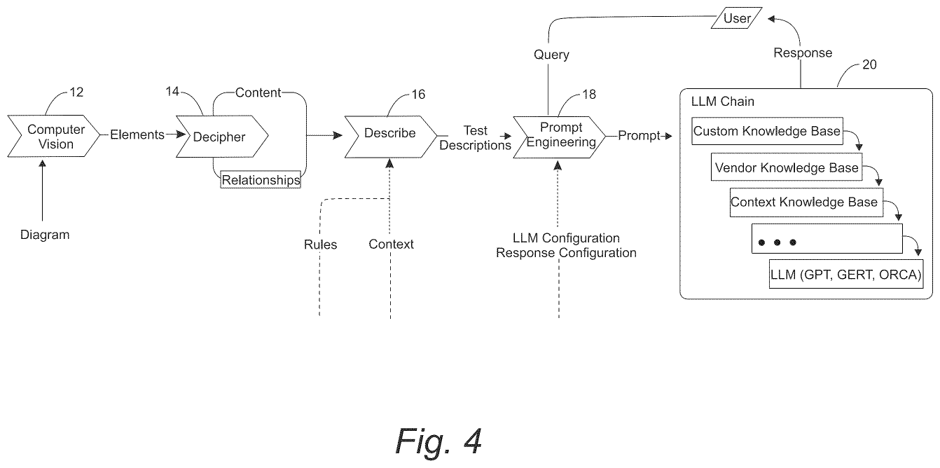

Referring to FIG. 4, an assistance use case applying Epiphany is schematically illustrated. Within different fields, users can upload diagrams (in PDF or image form) to ask questions about how to interpret and apply the diagrams. This can be used as a method of double-checking understanding of the diagram while on the job or for training.

Assistance Example 1: While working on a job at a car wash, an electrician needs to verify that the location his blueprint says to hook up a piece of machinery is correct, so he has to cross-reference the mechanic section of the blueprint. When he opens up this section of the blueprint on his phone via the Procore app, he notices that there is a note symbolized by “M-5” inside a square next to the piece of machinery to be installed. Instead of having to zoom out of the blueprint and navigate to the notes section of the page, he opens up the Epiphany chat and asks, “what does the M-5 note say?” The chat responds that the note says to install a plug at 90 inches instead of the normal 18 inches to line up with the machine plug and remain out of the way.

Assistance Example 2: On a busy day at a medical laboratory, a medical lab tech gets an error message on one of their urinalysis machines. Not knowing what the error message means, they open up the Epiphany chat on their lab computer and ask about the meaning of the error message. Epiphany responds that it usually indicates that there is a system jam within the machine and highlights a part of the diagram from the machine handbook that shows where the jam is most likely located. The tech asks for steps to follow to get rid of the jam and the chat responds with detailed instructions. The medical lab technician is able to successfully unjam the machine and resume their tests to give patients and doctors timely and accurate test results.

Assistance Example 3: A worker in a shared office space is printing documents when the printer stops working. They go to the front desk to ask for help, and the office space coordinator follows them back to the printer to check on the problem. When they take a look at the printer, they see an error code that has never been seen before, and the printer does not display any directions on how to troubleshoot the issue. They open up their Epiphany system on their phone and enter the printer model details and the error code. Epiphany returns the details from the printer handbook that describe the problem and how to fix it with a highlighted diagram specifying the location of the problem. After asking the system for more information, Epiphany returns back more detailed instructions on how to fix the printer.

### 3. Tutoring Use Case

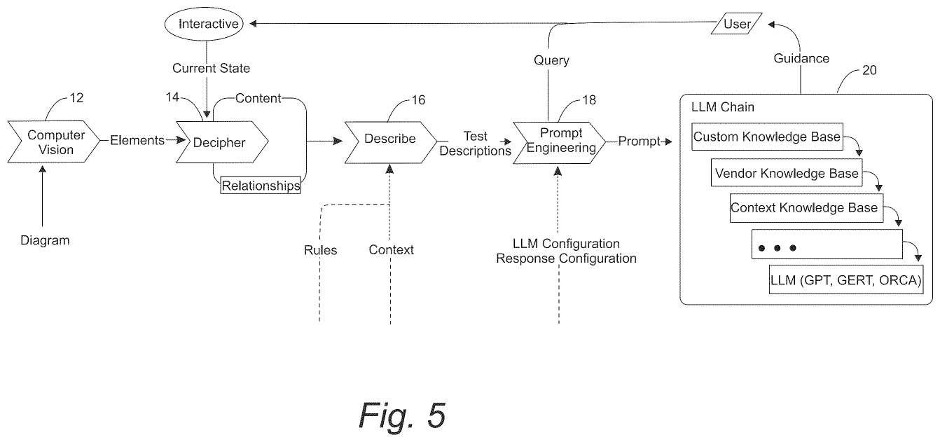

Referring to FIG. 5, a tutoring use case applying Epiphany is schematically illustrated. Embedded in interactives, users can get real-time feedback from Epiphany as they work on homework problems within an LMS or practice problems in the interactive playground. Using a rubric written by subject matter experts, Epiphany's tutor, Piph, can guide students to finding solutions and answers on their own.

Tutoring Example 1: A college student in a general chemistry class is completing an online homework assignment where she has to draw the Lewis structures of different molecules. One question says to build the Lewis structure of XeF6, and after she draws out her first attempt, she decides to check her work with the Piph tutor chat before submitting. Piph prompts her to check her total electron count. She checks this and decides to add a lone pair of electrons to the central atom and check her answer again. This time her answer is correct, and she is confident in her answer when she submits it. In the future, she remembers to check her total electron count when drawing Lewis structures.

Tutoring Example 1: In training to become an emergency medical technician (EMT), a student has a homework assignment to label all the bones of the human body in an online interactive. They open a Piph chat to double-check their work before submitting & ask for any errors in labeling. Epiphany prompts the student to check their work labeling the carpals, or wrist bones. After checking in their textbook, the student noticed that they incorrectly labeled the trapezoid and trapezium, so they corrected this before submitting the assignment.

### 4. Automated Diagram Training Use Case

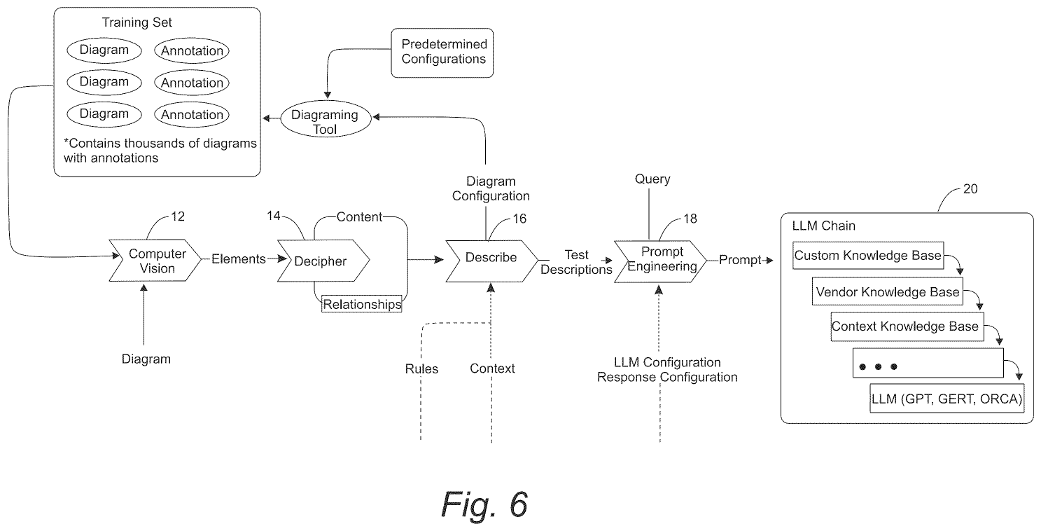

Referring to FIG. 6, an automated diagram training use case applying the Epiphany system is schematically illustrated. By combining a diagramming tool and predetermined configurations with the Epiphany system, thousands of diagrams and their annotations can be used to automatically train the computer vision system. This allows us to efficiently create versions of Epiphany that are able to interpret specific diagrams of different fields.

Automated Diagramming Example 1: A digital collaboration and diagramming platform, wants users to be able to interact with diagrams in their interface in a new way. The automatic annotation system can be integrated with their diagramming tool to generate thousands of diagrams and annotations to train Epiphany. Then, after the integration of the Epiphany system, users of a digital collaboration and diagramming platform will be able to ask Piph questions about their diagrams and receive helpful assistance in real time to understand and apply them.

### 5. Usability Study of Accessible Lewis Structure Explorer for Sighted and Blind/Low-Vision Users

### The Case for Accessibility and UDL

In the United States, all universities that receive federal funds or financial aid must meet civil rights laws for accessibility. Legal requirements on universities are driving an increase in awareness for accessibility, so in the classroom, faculty require additional materials and support to meet the accessibility needs of their students. In a separate study, we surveyed 21 post-secondary chemistry instructors from a variety of educational institutions about accessibility accommodations. Prior to recruitment the survey was reviewed and approved by an independent ethics review board (HML IRB, study #2015). Of these instructors, 6 reported they were required by their university to adopt learning tools that were accessible, and 12 indicated they did so to support an inclusive classroom environment. Of the 11 instructors who had taught a BLV student, only one felt adequately prepared to accommodate the student. Of these 11 instructors, the most common accommodation (n=8) was in the use of including alt text for chemical diagrams. Overall, these findings indicate that instructors would benefit from digital learning tools that include built-in accessible accommodations. Further details about this study are included in the Supporting Information (SI).

An approach for creating inclusive accessibility solutions is outlined with the Universal Design for Learning (UDL) framework to eliminate systemic barriers to success by using multiple means for “engagement, representation, and action” thus matching the widest possible range of users' needs. It was previously reported that one such UDL-designed interface for chemical particulate concepts, which used tactile manipulatives recognized by computer vision algorithms, provided an accessible input method for the chemistry interactives in a K-12 educational setting. Though useful for foundational spatial concepts, this multi-sensory interface is limited by the need for external hardware. A digital-only interface was desired to overcome these limitations and to provide a more scalable solution for building additional accessible digital interactives.

### Designing Usable Accommodations

Application of the UDL framework to a digital-only solution for BLV students helped identify the primary goals of the research and development for this project to be:
Develop a dynamic alt text generator for the Lewis Structure explorer
Develop an interface that does not require memorizing keyboard controls

Another requirement was that the system for alt text generation and the keyboard accessible interface was not specific for the Lewis Structure explorer and could be reproduced for other learning objectives and interactives. Access to the Lewis Structure explorer and a series of activities which use the explorer can be found at the authors' website.

### Dynamically Generated Alt Text

The first step in designing a system to generate alt text dynamically was to review standards and best practices for writing alt text. The most influential recommendation was the National Center for Accessible Media's (NCAM's) expod-Down Organization method which states best practices are to provide “a brief summary followed by extended description and/or specific data.” The first author applied the Drill-Down method to devise a “fill-in the blank” type script for describing Lewis structures. The second author then developed software that could compose text based on information from the configuration data generated by the interactive. For example, in the Lewis structure interactive for each atom the configuration data captures the identity, charge, bonds, lone pairs, and position.

The resulting descriptions were tested with a variety of use cases and the alt text script was iterated as needed. Once there was internal consistency of the results, the alt text was tested with the fourth author, who is congenitally blind and has earned a dietary science degree which included general and organic chemistry courses. This feedback was then used to clarify the alt text descriptions and improve them further. The result was alt text that is presented in a consistent format that follows best practices and appropriately applies chemistry terminology.

### Keyboard Accessible Control Panel

The initial accessibility interface used specific keyboard commands, as is recommended by WCAG. However, when this interface was tested with the fourth author, it became clear that the interface was not user friendly. The commands were hard to remember and little to no feedback was provided to inform the user when actions were successfully done. Through brainstorming sessions, we hypothesized that a form-based method (dropdowns, buttons, and numeric stepper) for controlling the explorer with the keyboard would be more intuitive. The order of the form also could follow the drilldown script for the alt text logic system. A second benefit to following the alt text logic system was that it was straightforward to extract the alt text for a specific component and re-word it slightly to give a useful description of the action that had been triggered by the form. Additionally, a button was included to deliver the dynamically generated alt text of the current drawing so users could check their progress as needed. The prototypes of the keyboard accessible control panel (KACP) were tested further with the fourth author to inform iterative development of the system. This co-design process with a SRU who understood chemistry was essential to creating the prototype.

Success of the dynamically generated descriptions and KACP was measured through a usability study with the Lewis structure explorer serving as the proof of concept for the method. The primary research questions were:
Do the descriptions provide sufficient information to accurately construct the described Lewis structure?
How satisfied are BLV individuals with the dynamically generated alt text?
Are BLV individuals successful in using the KACP and do they value its inclusion?

Prior to recruitment, all procedures were reviewed and approved by HML IRB (study #2146). User tests were conducted with 318 sighted chemistry college students and four BLV adult users. As it is not common practice for BLV individuals to produce images themselves, the sighted participants were asked to build Lewis structures within the interactive based on the dynamically generated alt text descriptions. This provided authentic representations of mental visualizations constructed based on the descriptions. Then, BLV users were presented the alt text and asked to decide which one of three tactile diagrams matched the description. The distractors were based on the images produced by the sighted users. After testing the alt text, BLV users were guided on how to use KACP to build a simple molecule and were asked to build a second molecule independently.

Study with Chemistry College Students

To answer research question 1, authentic user drawings of Lewis structures based on the information provided by the dynamically generated descriptions needed to be collected. Participants for the user test included college students enrolled in a chemistry course and who were 18 years or older. Students were instructed that their goal was to construct the Lewis structure in the interactive based on the description, regardless of whether the described structure was chemically feasible. There were ten descriptions, with half of the structures not feasible as a check that students were drawing based on the description and not chemical intuition.

Of the valid structures submitted, 81% were correct. (Data from this study are provided in the SI.) Across all the structures, most of the incorrect responses submitted had the correct basic skeletal structure. The errors were related to finer details, such as the number of lone pairs or formal charge label on an atom, all of which are included in the alt text. Therefore, these findings indicate the alt text is satisfactory for creating an accurate visual.

Study with BLV Users

Four BLV adults who regularly use a screen reader and rely on alt text to access non-text information in digital media participated in the second study. This number of participants was deemed sufficient to detect the majority of usability problems. Participants were asked to complete three problems where they had to pair alt text to one of three tactile Lewis structures (see SI for more details). Participants were not given any information about the pattern or structure of the alt text so that it would be roughly equivalent to encountering a description within a learning tool for the first time. After each problem a series of Likert-scale questions were asked to gauge the quality of the alt text and a semi-structured interview after the usability study provided further insight into participants' satisfaction.

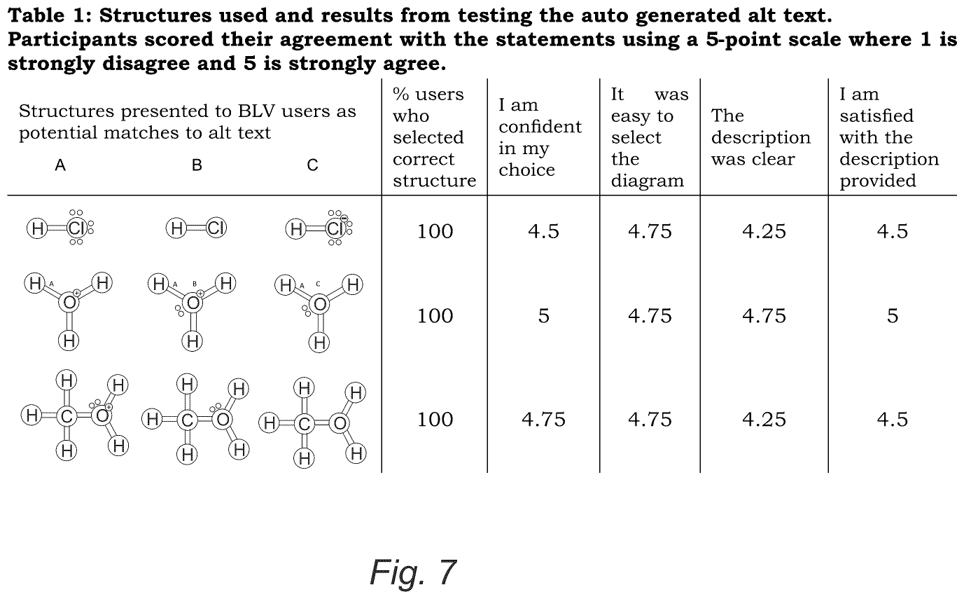

All participants identified the correct tactile structure for each problem giving a success rate of 100% across all participants. Further, for each problem all participants either agreed or strongly agreed with the statements: I am confident in my choice, it was easy to select the diagram, the description was clear, I am satisfied with the description provided (Table 1, FIG. 7).

During the interview participants expanded on their impressions of the alt text. In comparison to prior experiences with alt text one participant noted the clarity provided by the consistent descriptions. “The biggest problem I've always had with anything electronic is inconsistency. So looking at image to image the alt text doesn't follow the same pattern, there don't seem to be rules for the alt text, [but] this was very consistent, with very consistent rules.” Along with consistency, participants highlighted the alt text had a nice structure, “I liked the flow of it, that it gave me the general chemical formula then the specific components,” and appropriate amount of information, “it had enough detail to understand but didn't overload you with information.” Overall, participants reported satisfaction with the quality of the alt text even though two self-reported that they are usually harsh critics when testing technology made for the BLV community.

Next, the BLV users were given the opportunity to build using the KACP. To learn how to use the control panel participants were guided by the interviewer through a step-by-step process to draw ammonia, NH₃. One participant requested to try to use the control panel without any tutorial guidance and was able to build ammonia by only asking a couple of questions. On average, participants spent approximately 10 minutes going through the tutorial. During the tutorial participants voiced appreciation that after clicking a button that triggers an action, the system's ability to describe the action's result increased their confidence. The feedback allowed them to check their work as they built and to experiment to learn what each button did when clicked. As one participant explained, “You need time to work with something to make mistakes and learn what is good and bad before it works well and I was able to use it like almost instantaneously so that was very cool” and the feedback made that process quicker.

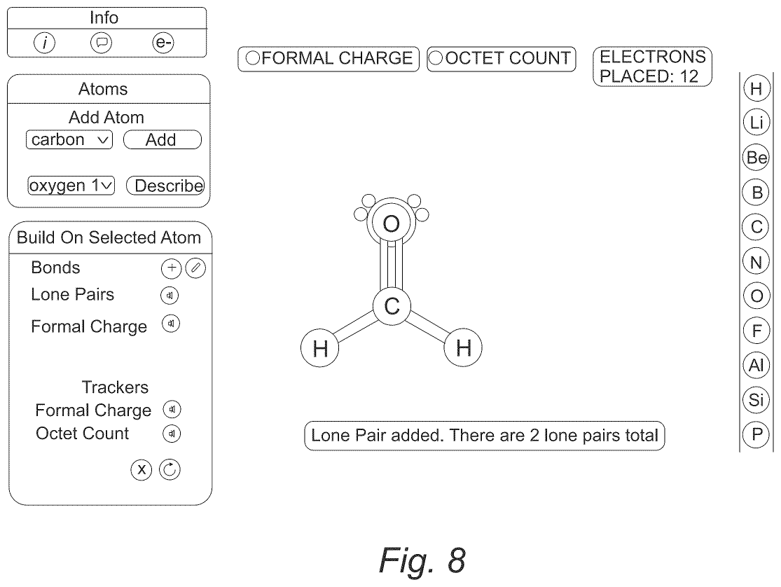

Once participants had all their questions answered, they were given a tactile diagram and description of formaldehyde (FIG. 8) and asked to draw it independently in the interactive. All participants independently used the controls and feedback to successfully build formaldehyde. Without prompting, every participant clicked on the button that reads the dynamically generated alt text to confirm the structure was complete and matched the tactile diagram. One participant finished in less than 2 minutes, two finished in under 4 minutes, and the last took about 10 minutes. When asked to rate the difficulty of using the drawing tool on a scale of 1 to 5 where 1 is very difficult and 5 is very easy, three of the four participants said easy or very easy. These findings confirm that the form-based accessible interface was usable, but perhaps more insightful were the interviews with participants.

When asked “what was your favorite thing about the drawing tool's controls” two mentioned the form-based design. The rapid feedback, made possible by the alt text generation system, was highlighted as important for usability. Beyond usability, two participants stated it was gratifying that they could draw something themselves for the first time. One participant requested an export button, so that the drawing could be readily shared with instructors or peers. All participants were pleased with what they could accomplish with the accessible chemical drawing system.

A major hypothesis that inspired development of a form-based control panel was that replacing a mouse with keyboard commands, while standard practice to meet accessibility standards, is not easy for BLV users to learn or apply. We asked participants to compare using the menu with a program that requires keyboard commands. One participant explained that . . .
it goes faster when you have those keyboard commands. But when you don't know it well, having to know keyboard commands is more tedious. Being able to navigate menus is better. So, if this was something I was going to use every day of my life, if I was going to be a Lewis structure builder, I would want keyboard commands but if it's something I'm going to use once in a while, for like a single unit [as in school], I think that the menu system is much better.

The quote supports our hypothesis that asking students to memorize keyboard commands for a learning tool that will only be used for a short time is unfeasible. Not only did the form-based control panel enable participants to draw a Lewis structure, but it also gave some their first experience with building and interacting with diagrams like “a normal person,” (a participant's own words) providing a perspective that those of us who are sighted often take for granted in our ever increasing visually centered digital world.

The reported studies were focused only on usability of the Lewis Structure explorer's interface. There are no claims from this research as to the effectiveness for learning Lewis Structures using the explorer for either the sighted or BLV study participants. Due to the low-incidence of the BLV population, which number less than 0.5% of student population in K-12, and is even a lower incidence population in college-level chemistry due to the BLV students steering away from STEM courses, group-based research studies for establishing the promise of outcomes for a learning tool with BLV students are not feasible. Even within this low-incidence population, there are significant differences in spatial perception between individuals with low-vision, or those whose blindness is either congenital or happened later in life. Single case design (SCD) methods, where BLV individuals serve as their own controls and the introduction of an intervention (the learning tool) is staggered across a small sample of participants, are the most common method for building the evidence base to demonstrate the effectiveness of a learning intervention with this population. Two SCD studies are planned with K-12 BLV students using accessible interfaces. Studies are also being structured to demonstrate the feasibility for inclusive use of the accessible interfaces for a BLV student within general population classrooms.

The accessibility system with the dynamically generated alt text and the form-based control panel has been integrated into five other digital explorers: three for chemistry (VSEPR, a particulate reactions explorer, and an organic chemistry sketcher), one for physics (optics), and one for elementary school math. The accessible VSEPR and particulate reactions explorers are also available on the author's website. Development has commenced on expanding the initial limited scope of the organic chemistry sketcher to provide an accessible and inclusive method for BLV students to learn and study independently in college-level organic chemistry.

The diagram export button requested by one of the study participants to provide a means of communication for BLV students also allows instructors a method for creating chemical drawings that include standardized alt text for use in their teaching practice. This feature is being designed so that the alt text is directly included in the meta-data of the image, thus creating a much needed system for producing usable and standardized alt text for chemical images. The multiple use cases for a single accessibility feature demonstrates the promise of using Universal Design for Learning as a framework for developing educational technology which is accessible-by-design and usable by all.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method comprising:
receiving a digitized image;
identifying elements in the digitized image as identified elements;
associating a contextual label to each element that becomes content for each element;
identifying predetermined relationships between the identified elements;
describing the content for each element individually and relationships between the elements with a predetermined language;
engineering a prompt to be sent to a Language Model (LM), the prompt being configured to provide an LM input and instruct the LM regarding a manner and configuration for responding to the LM input; and
receiving a response from the LM.

2. The method of claim 1, further comprising training a neural network to identify the elements in the digitized image, wherein the training comprises:
(a) collecting a dataset of annotated digitized images, wherein each image includes pre-labeled elements,
(b) applying data augmentation techniques to the collected dataset, including rotation, scaling, cropping, and noise addition, to improve the network's generalization capabilities;
(c) designing and implementing a convolutional neural network (CNN) architecture with multiple convolutional layers to detect spatial relationships between elements;
(d) using annotated images to train the neural network by adjusting network weights based on the identified elements and their relationships through forward and backward propagation; and
(e) evaluating the neural network's accuracy and performance using validation sets.

3. The method of claim 2, wherein the pre-labeled elements include chemical structures, electrical components, or blueprint symbols.

4. The method of claim 2, wherein the neural network's accuracy and performance are further evaluated using precision, recall, F1-score, and/or a confusion matrix to ensure reliable element recognition in digitized images.

5. The method of claim 1, wherein the prompt is further refined by a plurality of links in the LM chain.

6. The method of claim 5, wherein a custom knowledge base specifies phrases and keywords found and manipulated in a context of a predetermined goal.

7. The method of claim 1, wherein the language model is a small language model or a large language model.

8. The method of claim 1, wherein the response includes a detailed answer, guidance for a specific task, a detailed description of the digitized image, a detailed description of part of the digitized image, and/or alt text.

9. The method of claim 1, wherein the response includes an LM preamble, an LM response template, and textual descriptions that are sent to a Language Model Chain as the prompt.

10. The method of claim 1, wherein the elements are identified by a trained machine learning algorithm.

11. The method of claim 10, wherein the elements are identified by a trained neural network.

12. The method of claim 1, wherein the predetermined language is created by subject matter experts (SME).

13. The method of claim 1, wherein subject matter experts train a rules-based or AI system that provides contextual labels and expected relationships in a subject area.

14. The method of claim 1, wherein a rubric is provided by subject matter experts to filter content and relationships.

15. The method of claim 1, wherein the relationships are based on proximity of the elements in the digitized image.

16. The method of claim 1, wherein the digitized image is a raster image.

17. The method of claim 1, wherein the digitized image is a vector image.

18. The method of claim 1, wherein the digitized image is a 3D image.

19. The method of claim 1, wherein the predetermined language is specific for a category of the digitized image.

20. The method of claim 19, wherein the digitized image is an image of a chemical compound or chemical reaction.

21. The method of claim 20, wherein the elements include representations of atoms and chemical bonds.

22. The method of claim 21, wherein the elements further include representations of electron movement.

23. The method of claim 19, wherein the digitized image is an image for electrical diagram analysis.

24. The method of claim 19, wherein the digitized image is an image for blueprint analysis.

25. The method of claim 19, wherein the digitized image is an image for a plumbing system.

26. The method of claim 19, wherein the digitized image is an image for a plumbing system a mechanical system.

27. The method of claim 19, the digitized image is an image for building standards.

28. The method of claim 1, wherein one or more steps are executed by a computer.

29. A method for providing interactive STEM education tools accessible to blind and low-vision individuals, comprising:
generating, in real-time, alt text descriptions for diagrams based on configuration data from a STEM interactive tool, wherein said alt text descriptions comprise a contextual overview, component details, and relationships between components;
allowing user interaction with the tool through a form-driven, keyboard-accessible control interface, enabling the selection and manipulation of components in the diagram without the use of a mouse;
providing an artificial intelligence-driven learning assistant, configured to answer user queries based on the alt text descriptions, wherein the learning assistant offers personalized responses to clarify and guide the user in understanding and manipulating the diagram; and
embedding said alt text descriptions into the metadata of an exportable image generated from the STEM interactive tool, wherein said image file retains its accessibility for future use.

30. The method of claim 29, wherein the alt text generation engine applies a drill-down organization method to create the descriptions, wherein the overview provides a high-level summary, and additional layers of detail are available upon user request.

31. The method of claim 29, wherein the control interface includes drop-down menus, buttons, and selection options corresponding to diagram components, configured to present real-time updates and feedback as the user interacts with the tool.

32. A system for generating alt text for interactive STEM diagrams for blind and low-vision individuals, comprising:
an alt text generation engine configured to receive configuration data from a digital interactive system, wherein the engine automatically generates alt text descriptions based on the diagram's components, said alt text following a structured format of overview, detailed description, and component relationships;
a user interface, operable via keyboard controls, allowing the user to add, modify, and review components of the diagram, wherein feedback is provided through dynamically updated alt text that describes actions performed by the user; and
an artificial intelligence assistant integrated with the alt text generation engine, wherein the assistant responds to user inquiries, providing detailed or specific information about the diagram based on the alt text data.

33. The system of claim 2, further comprising a rubric-based feedback system, wherein the artificial intelligence assistant provides guided suggestions to help users improve their construction of the diagram, based on specific learning objectives.
